(19) United States
(12) Patent Application Publication
(10) Pub. No.: US 2012/0038602 A1
(43) Pub. Date: Feb. 16, 2012

(54) ADVERTISEMENT DISPLAY SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/090,263

(22) Filed: Apr. 20, 2011

(30) Foreign Application Priority Data
Aug. 16, 2010 (TW) 99127233

(51) Int. Cl. G09G 5/00

(52) U.S. Cl. 345/207

(57) ABSTRACT

In an advertisement display method, a plurality of reference images of an object to be advertised are captured and stored in a storage system of a computing device to create an image database of the object. Real-time scene images around a billboard are captured by the image capturing unit, and analyzed to detect whether there are people nearby the billboard. When a person is detected nearby the billboard, image data of the person are extracted from one of the scene images in which the person is detected and temporarily stored in the storage system, and a position of the person is determined according to the image data. A reference image of the object is selected from the image database according to the position of the person, and is displayed on a corresponding area of the billboard towards the position of the person.

### BACKGROUND

1. Technical Field

Embodiments of the present disclosure relate generally to advertisement displays, and more particularly, to an advertisement display system and method.

2. Description of Related Art

Columnar electronic billboards are widely used for advertising. Most typical columnar electronic billboards can only display one typical image of an object and cannot change different images of the object being displayed according to location of an individual, which restricts the effectiveness of the advertisement.

### BRIEF DESCRIPTION OF THE DRAWINGS

FIG. 1 is a block diagram of one embodiment of an advertisement display system including a computing device, an image capturing unit, and a billboard.

FIG. 2 is a schematic diagram illustrating one example of a plurality of cameras that are substantially equidistantly mounted on a top edge of the billboard of FIG. 1.

FIG. 3 is a flowchart of one embodiment of an advertisement display method using the system of FIG. 1.

FIG. 4 is a schematic diagram illustrating one example of the advertisement display system displaying images of a car according to a position of a person.

FIG. 5 is a schematic diagram illustrating one example for creating an image database of a car by capturing a plurality of images of the car based on different shooting angles.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

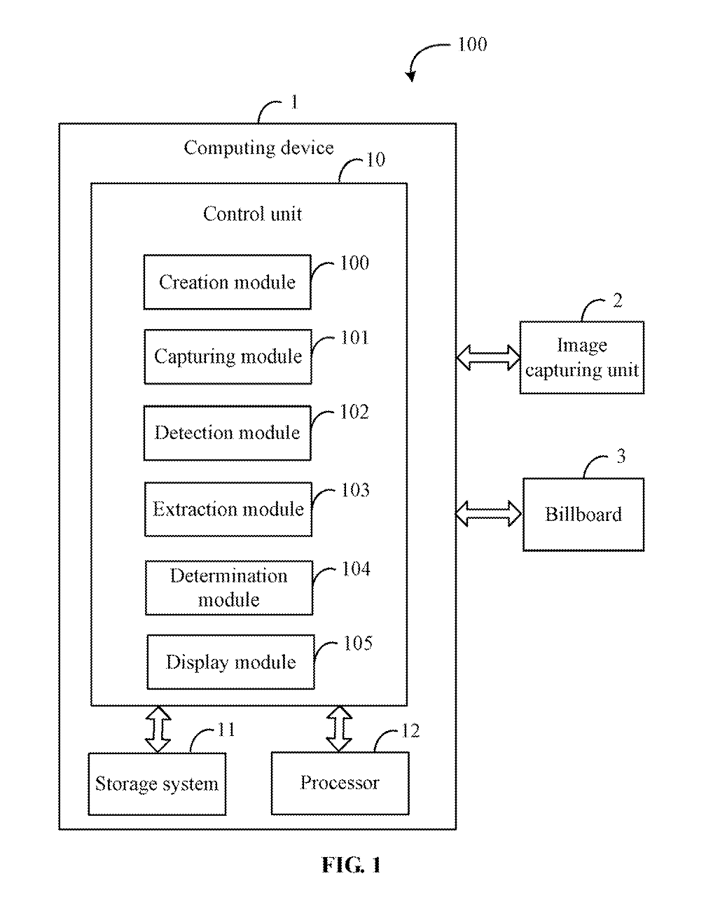

FIG. 1 is a block diagram of one embodiment of an advertisement display system 100 including a computing device 1, an image capturing unit 2, and a billboard 3. In the embodiment, the computing device 1 is electronically connected to the image capturing unit 2 and the billboard 3. The computing device 1 includes a storage system 11, a processor 12, and a control unit 10. In one embodiment, the computing device 1 may be a computer, a server, or a device for controlling the billboard 3. It should be apparent that FIG. 1 is only one example of the computing device 1 that can be included with more or fewer components than shown in other embodiments, or a different configuration of the various components.

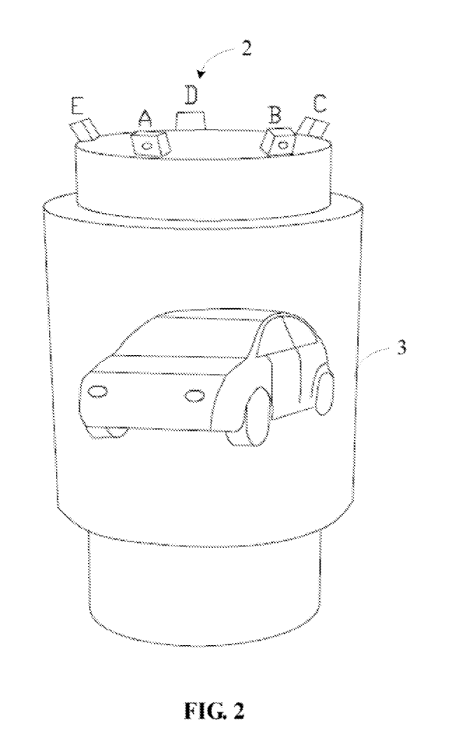

As shown in FIG. 2, the billboard 3 is a columnar electronic billboard in which an image of a car is displayed. The image capturing unit 2 may be composed of a plurality of cameras (e.g., A, B, C, D, E shown in FIG. 2) that are substantially equidistantly mounted on a top edge of the billboard 3 to form a circle. Each of the cameras captures images of an area near the billboard 3 so a 360-degree view can be captured and be viewed. The captured images may be transmitted to the computing device 1 and analyzed by the computing device 1, details are provided below.

The storage system 11 stores one or more programs, such as programs of an operating system, and other applications of the computing device 1. In one embodiment, the storage system 11 may be random access memory (RAM) for temporary storage of information, and/or a read only memory (ROM) for permanent storage of information. In other embodiments, the storage system 11 may also be an external storage device, such as a hard disk, a storage card, or a data storage medium. The processor 12 executes computerized operations of the computing device 1 and other applications, to provide functions of the computing device 1.

The control unit 10 may include a plurality of functional modules comprising one or more computerized instructions that are stored in the storage system 11 or a computer-readable medium of the computing device 1, and executed by the processor 12 to perform operations of the computing device 1. In the embodiment, the control unit 10 includes a creation module 100, a capturing module 101, a detection module 102, an extraction module 103, a determination module 104, and a display module 105. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

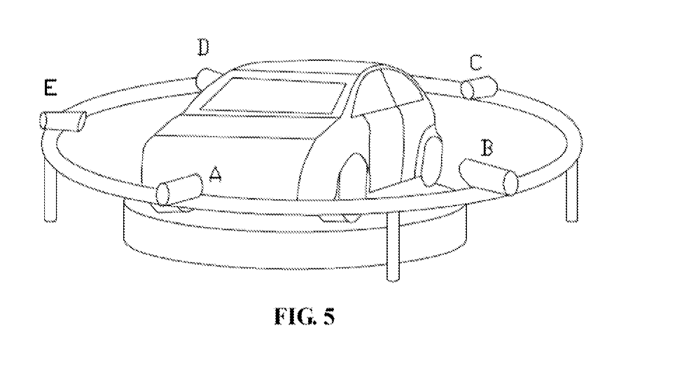

The creation module 100 is operable to capture a plurality of reference images of an object to be advertised based on different shooting angles using the image capturing unit 2, and store the reference images in the storage system 11 to create an image database of the object. In one example, as shown in FIG. 5, assuming that the object to be advertised is a car, each of the cameras A, B, C, D, and E of the image capturing unit 2 may capture a reference image of the car based on different shooting angles. Then each of the captured reference images may be named and can be stored in the storage system 11. For example, a frontal image of the car captured by the camera A may be stored in the image database and named as M0, a left side image of the car captured by the camera B may be stored and named as M1 correspondingly. Thus, an image database of the car is created. The shooting angles may denote that the reference images of the object have been shot by the image capturing unit 2 from different locations.

The capturing module 101 is operable to capture scene images around the billboard 3 using the image capturing unit 2 in real-time. In the embodiment, each of the scene images is an image of an area near the billboard 3, which includes objects in the area.

The detection module 102 is operable to analyze the scene images to detect whether there are people nearby the billboard 3 using a person detection method. In one embodiment, the person detection method may be a template matching method using neural network training algorithm and adaptive boosting (AdaBoost) algorithm.

When a person is detected nearby the billboard 3, the extraction module 103 is operable to extract image data of the person from one of the scene images in which the person is detected, and temporarily store the image data in the storage system 11. In one embodiment, the image data may be, for example, color characteristics, texture characteristics, facial features such as nose, eyes and mouth data, and width and height of the person.

The determination module 104 is operable to consecutively determine a position of the person according to the image data. In the embodiment, the determination module 104 may determine the position of the person according to which camera of the image capturing unit 2 captures the person. For example, if the image data is included in a scene image that is captured by the camera A, the determination module 104 determines that the person is in a coverage range of the camera A.

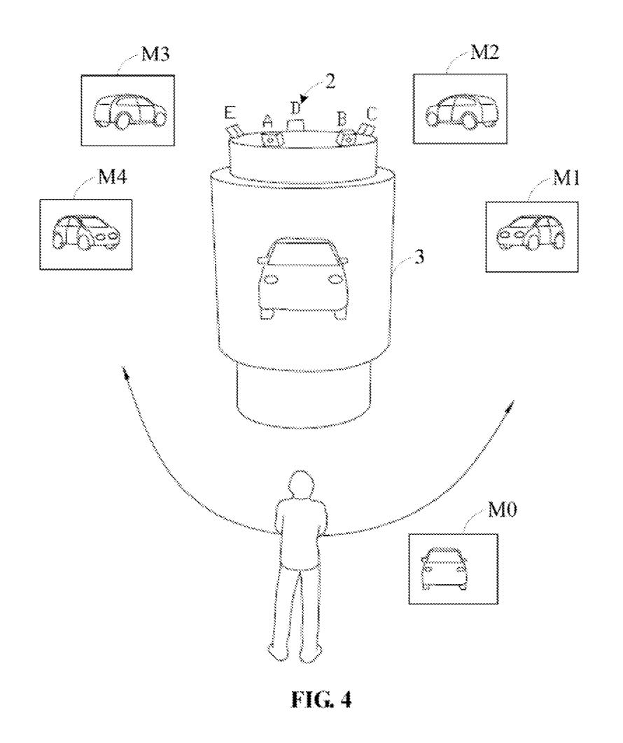

The display module 105 is operable to select a reference image from the image database of the object according to the position of the person, and display the selected reference image on a corresponding area of the billboard 3 towards the position of the person. In one example, as shown in FIG. 4, if the person stands in a coverage range of the camera A, the display module 105 selects a frontal image of the car (e.g., “M0”) from the image database of the car, and displays the frontal image “M0” on an area of the billboard 3 under the camera A. If a person stands in a coverage range of the camera B, the display module 105 selects a left side image of the car (e.g., “M1”) from the image database, and displays the left side image “M1” on an area of the billboard 3 under the camera B. As a result, when a person walks along the billboard 3, the person may watch different reference images of the car based on different shooting angles (e.g., M0, M1, M2, M3, and M4) wherever a person stands nearby the billboard 3. Furthermore, the display module 105 may constantly display a default image (e.g., “M0”) of the object on the billboard 3 when no person is detected nearby the billboard 3.

The determination module 104 is further operable to determine whether the person moves away the billboard 3 by consecutively checking whether the image data of the person is included in the real-time scene images captured by the image capturing unit 2. If the image data is included in the real-time scene images, the determination module 104 determines that the person has not moved away from the billboard 3. Otherwise, if the image data is not included in the real-time scene images, the determination module 104 determines that the person has moved away from the billboard 3. Upon the condition that the person has moved away from the billboard 3, the determination module 104 is further operable to delete the image data of the person from the storage system 11.

In the embodiment, the cameras of the image capturing unit 2 are prioritized according to a predetermined order of the cameras. Thus, when two or more of the cameras simultaneously captures a person nearby the billboard 3, the reference images of the object may be displayed on the billboard 3 according to position of a person captured by one of the cameras having a higher priority.

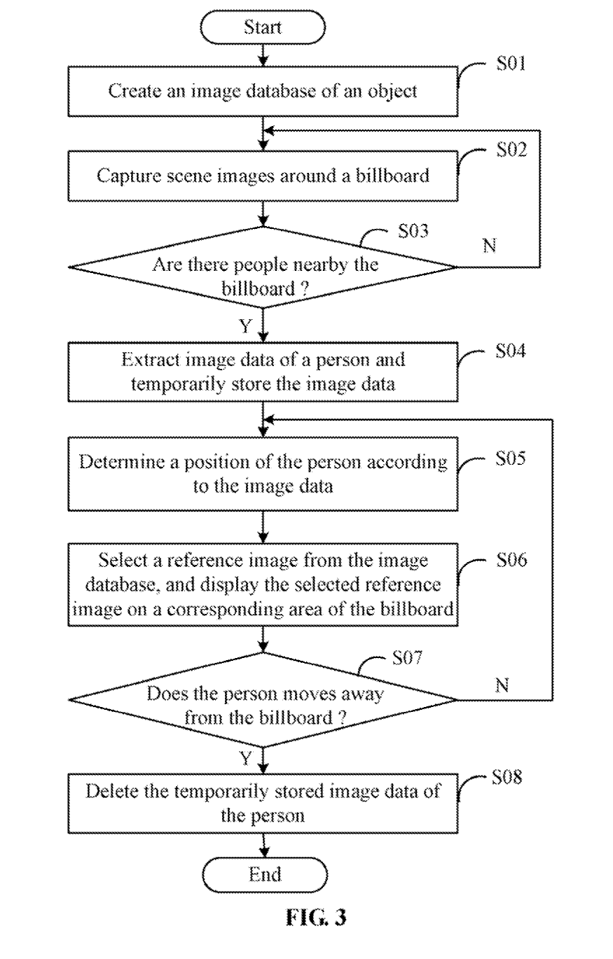

FIG. 3 is a flowchart of one embodiment of an advertisement display method using the system 100 of FIG. 1. Depending on the embodiment, additional blocks may be added, others removed, and the ordering of the blocks, may be changed.

In block S01, the creation module 100 captures a plurality of reference images of an object to be advertised based on different shooting angles using the image capturing unit 2, and stores the reference images in the storage system 11 to create an image database of the object.

In block S02, the capturing module 101 captures scene images around the billboard 3 using the image capturing unit 2.

In block S03, the detection module 102 analyzes the scene images to detect whether there are people nearby the billboard 3 using a person detection method. If there are people nearby the billboard 3, block S04 is implemented. Otherwise, if there are no people nearby the billboard 3, block S02 is repeated.

In block S04, the extraction module 103 extracts image data of a person from one of the scene images in which the person is detected and temporarily stores the image data in the storage system 11. The image data may be, for example, color characteristics, texture characteristics, facial features such as nose, eyes and mouth data, and width and height of the person.

In block S05, the determination module 104 determines a position of the person according to the image data. Details of determining the position are described as the paragraph [0017].

In block S06, the display module 105 selects a reference image from the image database of the object according to the position of the person, and displays the selected reference image on a corresponding area of the billboard 3 towards the position of the person. Details of the image selection and display are described as paragraph [0018].

In block S07, the determination module 104 determines whether the person moves away from the billboard 3 by checking whether the image data of the person is included in the real-time scene images captured by the image capturing unit 2. If the person moves away, block S08 is implemented. Otherwise, if the person does not does not moves away, block S05 is repeated. The determination module 104 may determine whether the person moves away using the method as described in paragraph [0019].

In block S08, the determination module 104 deletes the image data of the person from the storage system 11.

In the embodiment, the cameras of the image capturing unit 2 are prioritized according to a predetermined order of the cameras. Thus, when two or more of the cameras simultaneously captures a person nearby the billboard 3, the scene images of the object may be displayed on the billboard 3 according to position of a person captured by one of the cameras having a higher priority.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An advertisement display method based on a computing device that is electronically connected with a billboard and an image capturing unit, the method comprising:
capturing a plurality of reference images of an object to be advertised based on different shooting angles using the image capturing unit, and storing the reference images in a storage system of the computing device to create an image database of the object;
capturing scene images around the billboard using the image capturing unit in real-time;
analyzing the scene images to detect whether there are people nearby the billboard;
extracting image data of a person from one of the scene images in which the person is detected, and temporarily storing the image data in the storage system, when the person is detected nearby the billboard;
determining a position of the person according to the image data;
selecting a reference image from the image database of the object according to the position of the person; and
displaying the selected reference image on a corresponding area of the billboard towards the position of the person.

2. The method according to claim 1, further comprising:
determining whether the person moves away from the billboard by consecutively checking whether the image data of the person are included in the real-time scene images captured by the image capturing unit; and
deleting the image data of the person from the storage system when the person moves away from the billboard.

3. The method according to claim 1, wherein the billboard is a columnar electronic billboard.

4. The method according to claim 1, wherein the image capturing unit is composed of a plurality of cameras that are equidistantly mounted on a top edge of the billboard to form a circle.

5. The method according to claim 4, wherein the position of the person is determined according to which camera of the image capturing unit captures the person.

6. The method according to claim 4, wherein the cameras are prioritized according to a predetermined order of the cameras.

7. The method according to claim 6, wherein the reference images of the object are displayed on the billboard according to position of a person captured by one of the cameras having a higher priority, upon the condition that two or more of the cameras simultaneously captures a person nearby the billboard.

8. A computing device that is electronically connected with a billboard and an image capturing unit, the computing device comprising:
at least one processor;
a storage system; and
one or more programs stored in the storage system and being executable by the at least one processor, wherein the one or more programs comprises:
a creation module operable to capture a plurality of reference images of an object to be advertised based on different shooting angles using the image capturing unit, and store the reference images in the storage system to create an image database of the object;
a capturing module operable to capture scene images around the billboard using the image capturing unit in real-time;
a detection module operable to analyze the scene images to detect whether there are people nearby the billboard;
an extraction module operable to extract image data of a person from one of the scene images in which the person is detected, and temporarily store the image data in the storage system, when the person is detected nearby the billboard;
a determination module operable to determine a position of the person according to the image data; and
a display module operable to select a reference image from the image database of the object according to the position of the person, and display the selected reference image on a corresponding area of the billboard towards the position of the person.

9. The computing device according to claim 8, wherein the determination module further operable to determine whether the person moves away from the billboard by consecutively checking whether the image data of the person are included in the real-time scene images captured by the image capturing unit, and delete the image data of the person from the storage system when the person moves away from the billboard.

10. The computing device according to claim 8, wherein the billboard is a columnar electronic billboard.

11. The computing device according to claim 8, wherein the image capturing unit is composed of a plurality of cameras that are equidistantly mounted on a top edge of the billboard to form a circle.

12. The computing device according to claim 11, wherein the position of the person is determined according to which camera of the image capturing unit captures the person.

13. The computing device according to claim 11, wherein the cameras are prioritized according to a predetermined order of the cameras.

14. The computing device according to claim 13, wherein the reference images of the object are displayed on the billboard according to position of a person captured by one of the cameras having a higher priority, upon the condition that two or more of the cameras simultaneously captures a person nearby the billboard.

15. A storage medium storing a set of instructions, the set of instructions capable of being executed by a processor of a computing device to perform an advertisement display method, the method comprising:
capturing a plurality of reference images of an object to be advertised based on different shooting angles using an image capturing unit, and storing the reference images in a storage system of the computing device to create an image database of the object;
capturing scene images around a billboard using the image capturing unit in real-time;
analyzing the scene images to detect whether there are people nearby the billboard;
extracting image data of the person from one of the scene images in which the person is detected, and temporarily storing the image data in the storage system, when the person is detected nearby the billboard;
determining a position of the person according to the image data;
selecting a reference image from the image database of the object according to the position of the person; and
displaying the selected reference image on a corresponding area of the billboard towards the position of the person.

16. The storage medium as claimed in claim 15, wherein the method further comprises:
determining whether the person moves away from the billboard by consecutively checking whether the image data of the person are included in the real-time scene images captured by the image capturing unit; and
deleting the image data of the person from the storage system when the person moves away from the billboard.

17. The storage medium as claimed in claim 15, wherein the billboard is a columnar electronic billboard.

18. The storage medium as claimed in claim 15, wherein the image capturing unit is composed of a plurality of cameras that are equidistantly mounted on a top edge of the billboard to form a circle.

19. The storage medium as claimed in claim 18, wherein the position of the person is determined according to which camera of the image capturing unit captures the person.

20. The storage medium as claimed in claim 18, wherein the cameras are prioritized according to a predetermined order of the cameras.

21. The storage medium as claimed in claim 20, wherein the reference images of the object are displayed on the billboard according to position of a person captured by one of the cameras having a higher priority, upon the condition that two or more of the cameras simultaneously captures a person nearby the billboard.
